(19) United States
(12) Patent Application Publication
(10) Pub. No.: US 2021/0312183 A1
(43) Pub. Date: Oct. 7, 2021

(54) SYSTEM AND METHOD FOR HUMAN ACTION RECOGNITION AND INTENSITY INDEXING FROM VIDEO STREAM USING FUZZY ATTENTION MACHINE LEARNING

(71) Applicants: Nihar Shrikant Bendre, San Antonio, TX (US); Nima Ebadi, San Antonio, TX (US); Peyman Najafirad, San Antonio, TX (US)

(72) Inventors: Nihar Shrikant Bendre, San Antonio, TX (US); Nima Ebadi, San Antonio, TX (US); Peyman Najafirad, San Antonio, TX (US)

(73) Assignee: Board of Regents, The University of Texas System, Austin, TX (US)

(21) Appl. No.: 17/222,924

(22) Filed: Apr. 5, 2021

Related U.S. Application Data
(60) Provisional application No. 63/004,878, filed on Apr. 3, 2020.

(51) Int. Cl. G06K 9/00; G06N 3/08; G06N 3/04; G06K 9/62

(52) U.S. Cl. CPC G06K 9/00718; G06N 3/08; G06N 3/0445; G06K 9/00362; G06K 9/00744; G06K 9/6217; G06N 3/0436

(57) ABSTRACT

A system and method are provided for accurately recognizing actions and estimating action intensity. To enable the system to deal with the uncertainty and varied nature inherent in action recognition and intensity indexing, the system is a hybrid system that combines the concept of fuzzy logic and deep recurrent neural networks. The methodology is an attentive neuro-fuzzy system designed to recognize qualitative differences in human actions and to self-adapt to different intensities. The model of the system and method utilizes recurrent neural networks to detect actions from spatio-temporal patterns of human poses, in tandem with an adaptive fuzzy inference system to learn the various human motions used to perform actions with different intensities and then estimate the action's intensity. The integrated model can successfully learn the unique way a specific action with a certain intensity is performed and can estimate the intensity of the respective action.

### CROSS-REFERENCE TO RELATED APPLICATIONS

This application is a nonprovisional application that claims priority to, and the benefit of the filing date of, U.S. provisional application Ser. No. 63/004,878, filed on Apr. 3, 2020, entitled “SYSTEM AND METHOD FOR HUMAN ACTION RECOGNITION AND INTENSITY INDEXING FROM VIDEO STREAM USING FUZZY ATTENTION MACHINE LEARNING,” which is hereby incorporated by reference herein in its entirety.

### TECHNICAL FIELD

The invention relates to systems and methods for using machine learning to recognize actions and to estimate action intensity from video.

### BACKGROUND

Recently, action recognition based on supervised deep learning has attracted a lot of interest in the computer vision research community due to its numerous applications in video analytics, surveillance, security, sports analysis, and human-computer-interaction based applications. Researchers all over the world are doing extensive studies on various techniques to propose models with improved performance. Despite these efforts, this field still poses many challenges such as intra-class variation, viewpoint orientation, occlusion, various motion speed and different styles of background clutter. One drawback to the supervised deep learning approach of action recognition is that less focus is given to predicting the intensity of the action than to detect the action itself. Determining the intensity of an action is crucial in environments like bullying and violence detection in school, at work, at home, in public areas, and in prison. Intensity indexing can also be used for detecting aggressive behavior in applied behavior analysis (ABA), a proven assessment and treatment model for Autism Spectrum Disorder (ASD) and other severe mental disorders. In the context of ASD, intensity indexing can aid caretakers in assessing danger in patients' behavior and prevent serious health consequences such as concussion from head banging.

An action intensity index is defined as a measure of kinetic intensity used to determine whether a specific action is performed with high or low intensity. Kinetic intensity is the amount of kinetic power it takes to perform a certain action, and can be applied to the concept of indexing intensity of human actions. The kinetic power of a certain action is directly proportional to the velocity and the mass of the moving object. However, in the context of human activities, which involve the movement of human joints, the kinetic power depends on the velocity of the joints engaged in the main activity, as well as the number and extent in which they are engaged: more moving joints utilizing more joint power results in greater kinetic power and intensity.

The intensity of human actions cannot be generalized into a single, crisp formula as it varies from person to person. Intensity is rather a subjective term in which some level of uncertainty is always present, often expressed using imprecise language. Furthermore, measurement inaccuracies are inevitable from a 2D video. Therefore, to measure the intensity of an action from an input video, a mathematical model is required which accounts for such uncertainties and inaccuracies by modelling and minimizing their effects.

While deep learning-based models can help with learning adaptation and scaling up to more general applications, they cannot capture data or model uncertainty. In addition, deep learning-based models lack the human-like ability to interpret imprecise information. In the context of intensity indexing, deep learning-based models also encounter serious problem when the dataset is biased towards a specific way of performing an action. These models are not able to learn dissimilarities in human motions when actions are performed with various intensities.

A need exists for a machine learning system and method that are capable of accurately recognizing actions and action intensity.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIGS. 1A and 1B show photographs of a first subject, subject A, punching hard and soft, respectively, and show how the distribution of attention weights (over joints and time) changes with the intensity index of the performed action; the line plot indicates attention over time frames and the bar plot indicates attention over the joint movements.

FIGS. 1C and 1D show photographs of a second subject, subject B, punching hard and soft, respectively, and shows how the distribution of attention weights (over joints and time) changes with the intensity index of the performed action. Even though both subjects are performing the same action, the distributions of attention weights are different.

FIG. 2 is a flow diagram of the method in accordance with a representative embodiment.

FIG. 3 is a block diagram of the LSTM recurrent architecture with spatio-temporal attention mechanisms in accordance with an embodiment.

FIG. 4 is a block diagram of the Kinetic Fuzzy Intensity Analysis stage shown in FIG. 2 in accordance with an embodiment.

FIG. 5 shows a table that compares state-of-the-art action recognition models trained on the SBU dataset and gives results that highlight the importance of the spatio-temporal attention mechanism, which improves the accuracy of the ST-LSTM; the table shows how the ST-LSTM model with attention mechanism enhances the accuracy of the model of and achieves the state-of-the-art performance on SBU Kinetic dataset.

FIG. 6 shows a table that depicts the re-evaluation results obtained by the system on an additional generated dataset showing an average 2.75% decrease in the overall accuracy.

FIG. 7 shows a table that depicts the action intensity indexing performance of the integrated model of the present disclosure on a generated dataset and shows that by using both fuzzy rules jointly, a higher precision is achieved.

FIG. 8 shows a table of the evaluation results obtained by the system.

FIGS. 9A-9D are graphs of a generalized bell membership function fitted to these weighted distribution of joints corresponding to the attention weights of the LSTM module by assigning a membership score of 1 if the detected index is intense, and 0.5 if the distribution is closer to the intense category but the final intensity score is below the threshold.

FIG. 10 is a flowchart representing the machine learning method in accordance with a representative embodiment for action recognition and intensity indexing using a fuzzy recurrent attention technique.

FIG. 11 is a block diagram of the machine learning system in accordance with a representative embodiment in which the three-stage system shown in FIG. 2 is implemented in software running on one or more processors.

### DETAILED DESCRIPTION

In accordance with the present disclosure, a system and method are provided for accurately recognizing actions and estimating action intensity. In contrast to known deep learning-based models, fuzzy inference systems, provide an inference mechanism for uncertainty and enable the qualitative interpretation of the actions. Adaptive fuzzy systems can generate membership functions for different types of target action intensities. To enable the system disclosed herein to deal with the uncertainty and varied nature inherent in action recognition and intensity indexing, the system is a hybrid system that combines the concept of fuzzy logic and deep recurrent neural networks. Such integration has proven effective in a wide variety of real-world problems. The methodology disclosed herein is an attentive neuro-fuzzy system designed to recognize qualitative differences in human actions and to self-adapt to different intensities. The model of the system and method utilizes recurrent neural networks to detect actions from spatio-temporal patterns of human poses, in tandem with an adaptive fuzzy inference system to learn the various human motions used to perform actions with different intensities and then estimate the action's intensity. The integrated model can successfully learn the unique way a specific action with a certain intensity is performed and can estimate the intensity of the respective action. Experimental results prove the effectiveness of the integrated model in recognizing the action movements of different intensities. The integrated model is believed to be the first to index the intensity of action from an input video.

In summary, the present disclosure discloses a novel hybrid model based on a fuzzy inference system coupled with a spatio-temporal Long Short-Term Memory (LSTM) action recognition module to jointly determine the intensity index of the recognized action. The present disclosure also provides a case study on a generated dataset of human actions with two intensity indexes: intense and mild, to evaluate the performance of our model in more fine-grained recognition of actions and intensities. The present disclosure demonstrates through experimental results that indexing of the action intensity is possible. The integrated model is analyzed herein by applying it to videos of human actions with different action intensities to demonstrate that it is able to achieve an accuracy of 89.16% on an intensity indexing generated dataset. The integrated model demonstrates the ability of a neuro-fuzzy inference module to effectively estimate the intensity index of human actions.

In the following detailed description, a few illustrative, or representative, embodiments are described to demonstrate the inventive principles and concepts. For purposes of explanation and not limitation, representative embodiments disclosing specific details are set forth in order to provide a thorough understanding of an embodiment according to the present teachings. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

The terminology used herein is for purposes of describing particular embodiments only, and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a computer-readable storage medium that is capable of storing computer instructions, or computer code, for execution by one or more processors. References herein to “memory” or “memory device” should be interpreted as one or more memories or memory devices. The memory may, for example, be multiple memories within the same computer system. The memory may also be multiple memories distributed amongst multiple computer systems or computing devices.

A “processor” or “processing logic,” as those terms are used herein, encompass an electronic component that is able to execute a computer program, portions of a computer program or computer instructions. References herein to a computer comprising “a processor” should be interpreted as a computer having one or more processors or processing cores. The processor may, for instance, be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

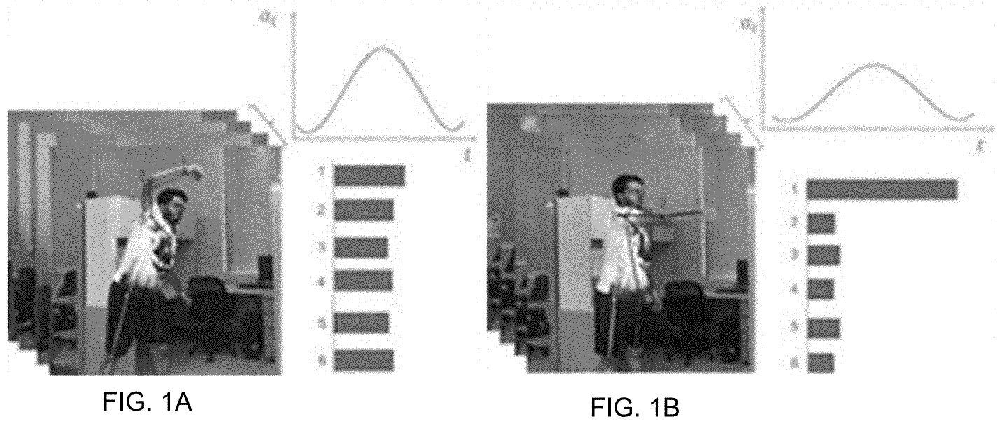

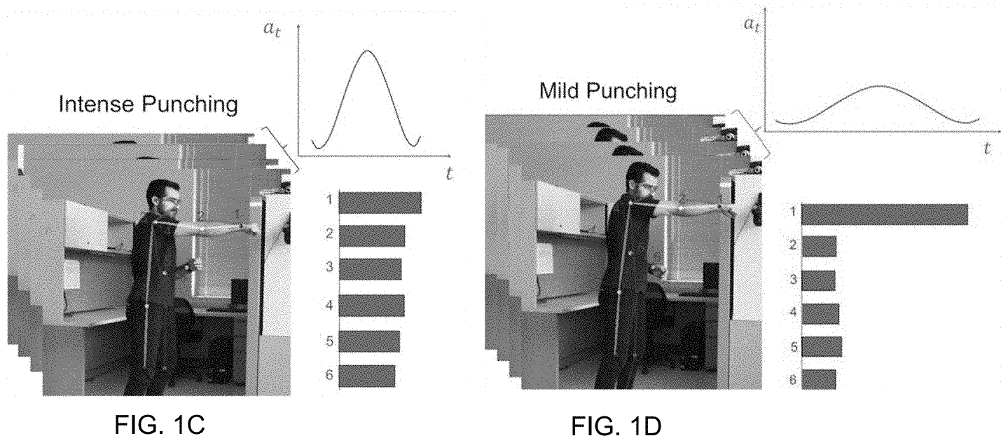

FIGS. 1A and 1B show photographs of a first subject, subject A, punching hard and soft, respectively, and show how the distribution of attention weights (over joints and time) changes with the intensity index of the performed action. The line plot indicates attention over time frames and the bar plot indicates attention over the joint movements. FIGS. 1C and 1D show photographs of a second subject, subject B, punching hard and soft, respectively, and shows how the distribution of attention weights (over joints and time) changes with the intensity index of the performed action. Even though both subjects are performing the same action, the distributions of attention weights are different. The model leverages deep learning components as well as neuro-fuzzy systems to dynamically generate fuzzy logic rules to detect the intensity of various human actions. To detect actions using human key-point coordinates, the model uses spatio-temporal information of the scene so it can also be seen as a time series problem. To overcome this, much research has been done in the recent past to create models that can effectively predict actions from key-point coordinates. Traditional methods involved features which were hand crafted to represent the inter frame relationship of the key-point coordinates sequence. Recent studies have utilized deep learning techniques to detect and predict relationships by using spatio-temporal information in a collection of frames. A Fine-to-Coarse Deep Convolutional Neural Network (CNN) has been used along with fully connected layers which extract the spatio-temporal and spatial features of a key-point coordinates sequence. Furthermore, the use of 3D-CNN with a 3D filter kernel has also been proven to be able to learn the spatio-temporal information. To capture temporal information, research has been done to predict action using Recurrent Neural Networks (RNNs), which are based on LSTM or Attention Models. Few research examples exist where a RNN based model has been used to predict the actions from human key-point coordinates. Recent research also points to the use of a Convolutional-Recurrent Neural Network (CRNN) where the CNN is used to extract the features from the input frames and the output of the CNN is fed to LSTM to extract the temporal dynamics. State-of-the-art results were achieved with the use of a graphical neural network. Compared to the graphical neural network and LSTM, CNN displays better results for learning to represent images in terms of key-point coordinates representation, but their performance drops when dealing with long spatio-temporal sequences.

While deep learning models can achieve better scalability and can generalize better, they lack in capturing data uncertainty, subjectivity and human-like reasoning. Fuzzy logic can capture the uncertainty, subjectivity and have human-like reasoning. The system and method of the present disclosure use fuzzy inference on top of a deep learning action recognition module to index intensity of the action as either mild or intense. Indexing the intensity of a subjective task involves a certain amount of uncertainty from individual to individual. It requires adaptive learning, which cannot be derived by just stacking various modules sequentially. The system and method of the present disclosure provide a novel neuro-fuzzy system that uses recurrent neural networks and fuzzy inference systems to adaptively perform fine-grained recognition of human action intensity indexes.

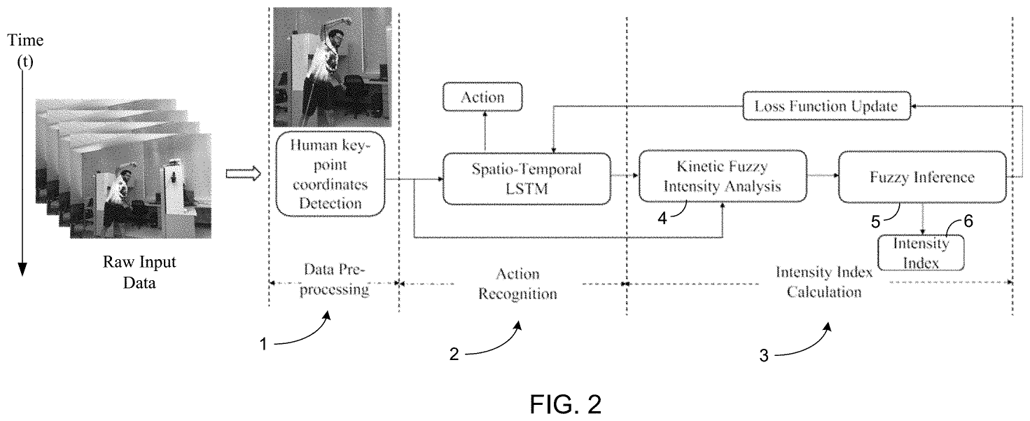

FIG. 2 is a flow diagram of the method in accordance with a representative embodiment. The camera frames act as an input to the data pre-processing stage 1 that generates the human key-point coordinates. These coordinates act as an input to the Spatio-Temporal LSTM 2, which detects the actual action and generates the attention weights. These weights are the input to the Kinetic Fuzzy Intensity Analysis stage 3, which generates the intensity score. This intensity score dynamically updates the fuzzy logic rules and is also used to determine the Intensity Index of the performed action.

Thus, the methodology, in accordance with a representative embodiment, comprises three processing stages: the data preprocessing stage 1, the action recognition stage 2, and the intensity indexing stage 3. First, the preprocessing stage 1 transforms the input video of an action to a tensor of the human key-point coordinates over time using a pose detection algorithm. This tensor is next passed to an LSTM network 2 to recognize the human action based on the spatio-temporal patterns existing in the tensor. In accordance with an embodiment, the LSTM model is equipped with two self-attention mechanisms, one over the time frames and another over the coordinates. The attention weights, along with the coordinate's tensor, are then fed to the kinetic fuzzy intensity analysis module 3. The kinetic fuzzy intensity analysis module 4 computes an initial intensity score based on fuzzy entropy measures. The fuzzy inference module 5 converts the intensity score and the attention weights into fuzzy sets using an adaptive membership function. Using the truth values of these fuzzy sets, the methodology defines the fuzzy rules through which the final intensity index 6 is determined. Finally, the spatio-temporal LSTM's loss function gets updated with a customized penalty term to further adapt to distinct movements of intense-mild actions.

A. Data Pre-Processing

Before the raw data can be input into the action recognition module, human key-point coordinates are generated using the pose estimation technique. Using human key-point coordinates to train the action recognition module helps reduce the background clutter. It also reduces the computational complexity as compared to using the entire image/video to train the module. The human key-point coordinates are also fed to the neuro-fuzzy section 3 for qualitative action recognition. To extract the human key-point coordinates, a known model can be used that is known to achieve state-of-the-art results on multiple public benchmarks for pose estimation and human key-point detection.

B. LSTM with Spatio-Temporal Attention

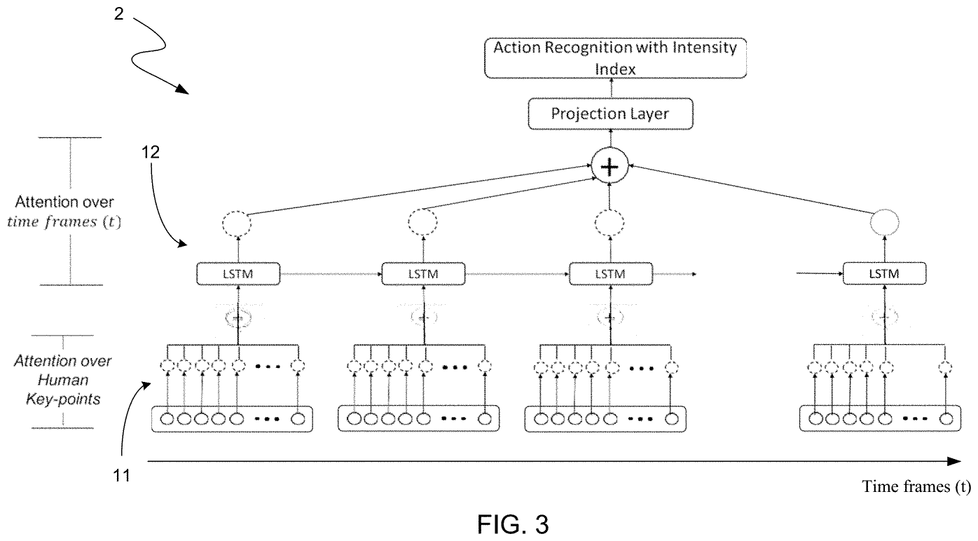

FIG. 3 is a block diagram of the LSTM recurrent architecture with spatio-temporal attention mechanisms in accordance with an embodiment. The attention over human key-points 11 defines the parts of the human bodies from which the action can be observed and the attention over time frames 12 defines the video frames in which the action is being performed. The number of attention weights also shows the significance of the corresponding value in recognition of the action. For supervised deep learning, there are various known LSTM models that have developed for action detection. The spatio-temporal LSTM model 2 of the present disclosure utilizes two attention mechanisms, namely, the attention over the time frames 12 and the attention over various key-point coordinates 11. Such spatio-temporal attention helps the model 2 to understand an action despite variation among individuals preforming the same action with a certain intensity index, such as walking fast or punching hard. One attention mechanism is implemented on top of the recurrent architecture of the LSTM cells, and the other one is implemented across the units of input and hidden states, so that the model 2 can selectively focus on the time frames as well as human key-point coordinates. These two attention mechanisms 11 and 12 demonstrate the engagement of the human key-point coordinates in each time frame in the detected action. In addition to learning the possible behavioral variation of performing an action, the weights of these two attention mechanisms are used in stage 3 (FIG. 2) to measure the kinetic intensity score and determine the fuzzy inference of the intensity index.

C. Kinetic Intensity Score Using Fuzzy Entropy

Once the attention LSTM model 2 is trained to recognize the performed action, the parameters of the attention vectors are utilized along with fuzzy entropy measures to compute an initial intensity score for an instance of the action. This initial kinetic intensity score is utilized to generate dynamically fuzzy rules to specify the index of the intensity, e.g., intense or mild. As shown in FIG. 3, the Spatio-Temporal LSTM model 2 is equipped with a self-attention mechanism that detects the time frames in which the detected action is happening, extracting a linear combination of the hidden states to the output and generating the temporal attention weights. These weights denote the amount of influence of each time frame in the final inference. In other words, they determine whether, and to what confidence level, an action is observed in each time frame. The distribution of these weights can be used to measure the intensity of the action. For instance, the faster an action happens, the observation of the performed action in time is less, and the resultant distribution of temporal attention weights is proportionally denser.

Therefore, the entropy of these attention weights has an inverse relationship with the intensity and speed of an action. The intensity of action depends on the kinetic energy of the limbs that are engaged in performing the action which are translated into key-point coordinates. This kinetic energy can be formulated by the movement of the key-point coordinates over the video frames. Thus, this kinetic energy is considered by adding it to the attention distribution as fuzzy membership weights and computing their fuzzy entropy. The weights are the change of the coordinates' locations from the last frame multiplied by their corresponding attention weights. Using known fuzzy entropy methods, the fuzzy entropy of the attention vector can be calculated, which is indirectly related to intensity, as follows:

$$\begin{matrix}{H}_{fuzzy} ( {a}_{t} , {μ}_{t} ) = - {\dot{\sum }}_{t = 1} {a}_{t} \cdot {μ}_{t} \cdot log ( {a}_{t} ) & ( 1 ) \\ {μ}_{t} = \frac{1}{( {a}_{t} \cdot \vert Δ {x}_{t} \vert )} = \frac{1}{( {a}_{t} \cdot \vert {x}_{t} - {x}_{t - 1} \vert )} & ( 2 ) \\ ⟹ {H}_{fuzzy} ( {a}_{t} , Δ {x}_{t} ) = - {\sum }_{t = 1}^{T} \frac{log ( {a}_{t} )}{\vert {x}_{t} - {x}_{t - 1} \vert} & ( 3 )\end{matrix}$$

where, xₜ is the input at the time frame t, Δₜ is the weight for H_{fuzzy}(aₜ, Δₜ) at time t and aₜ is the attention weight over time frame t.

Furthermore, the intensity of an action also depends on the number of the engaged joints. As a concrete example, an intense punch, in comparison to a mild one, includes the movement of a greater number of joints across more dimensions such as hip rotation and non-dominant hand movement. The same concept has been used to quantify the intensity of human facial actions by the number of engaged coordinates and how much they are engaged. As such, a multi-dimensional attention over the human key-points coordinates is also extracted. Just as the fuzzy entropy of the directional attention was calculated, the fuzzy entropy of the dimensional attention is also calculated, which is directly related to intensity. The fuzzy weights are the product of temporal attention and dimensional attention over every time frame.

$${H}_{fuzzy}^{′} ( {a}_{( j , t )}^{′} , {a}_{t} ) = {\sum }_{t = 1}^{T} {a}_{t} \cdot {\sum }_{j = 1}^{J} {a}_{( j , t )}^{′} \cdot log ( \frac{1}{{a}_{( j , t )}^{′}} ) \qquad ( 4 )$$

where aₜ, attention weight over time frame t, is the fuzzy weight. a_{(j,t)} is the attention weights over the key-point coordinate (i.e. human joints) at time frame t.

Finally, considering both kinetic energies, intensity is formulated as the proportion of the fuzzy entropy in Equation 4 over the fuzzy entropy in Equation 3. In other words, we measure the kinetic intensity through the fuzzy entropy of the attention weights over the coordinate's locations divided by the fuzzy entropy of the attention weights over the time frames. As follows:

$$I = \frac{{H}_{fuzzy}^{′} ( {a}_{( j , t )}^{′} , {a}_{t} )}{{H}_{fuzzy} ( {a}_{t} , \vert Δ {x}_{t} \vert )} \qquad ( 5 )$$

where I is the intensity score, a_{(j,t)}′ is the attention weight over the key-point joint j at time frame t is equal to the j^{th} element of the output gate at time t.

D. Fuzzy Inference for Intensity Indexing

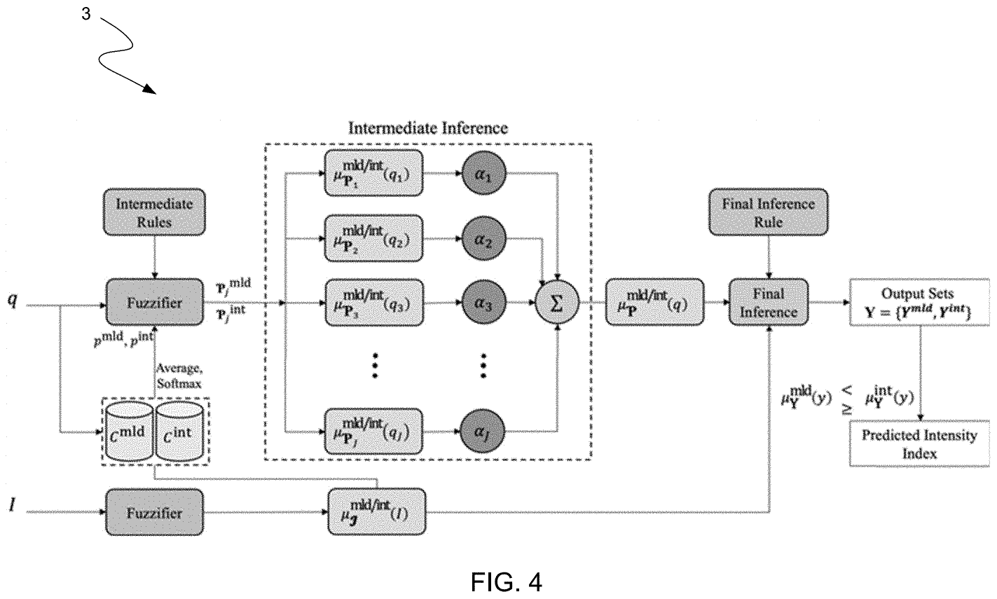

As mentioned above, intensity is not a very precise term and there is no general formula to measure a crisp value of it. Therefore, after computing the kinetic intensity score, our methodology uses an adaptive fuzzy inference system to detect the intensity index based on both the kinetic intensity score I computed from the previous section, and distribution of the joints' attention weights q qⱼ as motion patterns. These two values are fed to our fuzzy inference system as crisp input values. This procedure is illustrated in FIG. 4, which is a block diagram of the Kinetic Fuzzy Intensity Analysis stage 3 shown in FIG. 2 in accordance with an embodiment.

1) Fuzzification of Intensity Score and Joints' Distribution

The following discussion describes the fuzzification algorithm performed by the stage 3. In this regard, using dynamically learned membership functions, these crisp input values are mapped to fuzzy sets:

I={I^{mld}, I^{int}} and Pⱼ={Pⱼ^{int}, Pⱼ^{mld}},² which denote which denote the partitioning of the intensity score and attention weight corresponding to joint j, respectively, into mild and intense regions. Our fuzzy inference system looks at these fuzzy sets as rough estimations of the intensity index. However, the final intensity index output is computed based on these rough estimations and fuzzy logic. The model dynamically learns fuzzy membership functions for these fuzzy sets, i.e. μI and μPj, based on the previously computed kinetic intensity score and the distribution of the corresponding attention weights. Using the average intensity index and the common triangular shape, the fuzzy membership μI is formulated as below:

$${μ}_{ℐ}^{mld / int} ( I ) = max ( 0 , 0.5 + \frac{∓ ( I - I )}{σ} ) \qquad ( 6 )$$

where, [symbol] (I) refers to the truth values of [symbol] ^{mld} and/or [symbol] ^{int} respectively. Ī is the averaged intensity score, which dynamically gets updated. σ defines the spread of the fuzzy set, larger values denote more uncertainty is assumed to exist

The membership function μ [symbol] ⱼ is adaptively computed using the membership function of the equation above and categorized distribution of joints' attention weights along with normalized cross-entropy distance. This process is elaborated upon in the followings: Firstly, the model stores the intensity scores of every action as well as the relative attention weights of the spatio-temporal LSTM network. Next, by comparing the truth values of I^{mld} and I^{int}, the stored attention weights can be categorized into the following categories:

$$\begin{matrix}{C}^{mld} = \{ {a}_{ij} = \frac{{μ}_{ℐ}^{mld} ( {I}_{i} )}{{T}_{i}} {\sum }_{t = 1}^{{T}_{i}} {a}_{i}^{′} ( j , t ) \vert {μ}_{ℐ}^{int} ( {I}_{i} ) \leq {μ}_{ℐ}^{mld} ( {I}_{i} ) \} & ( 7 ) \\ {C}^{int} = \{ {a}_{ij} = \frac{{μ}_{ℐ}^{int} ( {I}_{i} )}{{T}_{i}} {\sum }_{t = 1}^{{T}_{i}} {a}_{i}^{′} ( j , t ) \vert {μ}_{ℐ}^{int} ( {I}_{i} ) > {μ}_{ℐ}^{mld} ( {I}_{i} ) \} & ( 8 )\end{matrix}$$

where: i∈{1, 2, 3, . . . , N} and j∈{1, 2, 3, . . . , J}
   and where, aᵢⱼ is the sample index, Tᵢ is the number of times frames in i^{th} sample, (j,t) is the joint index, N is the number of samples and J is the number of joint coordinates, Tᵢ is the number of time frames in the i^{th} sample, aᵢⱼ is the corresponding joint attention weight averaged over the time frames.

Every weight is multiplied by the corresponding μ [symbol] to highlight those with higher certainty. Then, by taking the average over various samples of every action, a customized distribution of joints' weights is derived for each category of intense-mild. The softmax of these weights can then be calculated to convert them into probabilistic distributions:

$${p}^{mld / int} = \{ {p}_{j}^{mld / int} = softmax ( \frac{1}{N} {\sum }_{j = 1}^{N} {a}_{ij} ) \vert ∀ {a}_{ij} ∈ {C}^{mld / int} \} \qquad ( 9 )$$

Similarly, a probabilistic distribution of joints' weights for every new input sample can be derived as follows:

$$q = \{ {q}_{j} = softmax ( \frac{1}{{T}_{N + 1}} {\sum }_{t = 1}^{{T}_{N + 1}} {a}_{( j , t )}^{′} \vert ∀ j ∈ \{ 1 , 2 , 3 , … , J \} \} \qquad ( 10 )$$

Finally, the μ [symbol] _{ⱼ}(q) can be calculated based on a normalized cross entropy distance between, qⱼ and (pⱼ^{int}, pⱼ^{mld}); and triangular shape according to the following equation:

$${μ}_{{𝒫}_{j}}^{mld / int} ( {q}_{j} ) = max ( 0 , 0.5 + \frac{∓ ( Δ H - Δ \overline{ H} )}{{σ}^{′}} ) \qquad ( 11 )$$

where (ΔH=H(Pⱼ^{int}, qⱼ)−H(Pⱼ^{mld}, qⱼ)) in which H(Pⱼ^{int}, qⱼ) and H(Pⱼ^{mld}, qⱼ) are the cross-entropy between the softmax activation of the attention weight distributions of intense-mild categories in Equation 9 and those of the current input sample computed in Equation 6. ΔH̅ is the average of these differences for all stored samples and σ′ defines the spread of the fuzzy set.

Below is the pseudocode for a first algorithm, Algorithm 1, performed by the in the first portion of the Fuzzy Inference System of stage 3 (FIG. 2), which corresponds to fuzzification of intensity score I and Joints' distribution q= [symbol] qⱼ [symbol] . This process is performed for every input video and the values are updated dynamically to dynamically adapt to different action intensity indexes.

```
  Ĩ: average intensity score
  Δ\tilde{H}: average difference between the cross-entropy of mild
  and intense distributions
  C^{int}: collection of joint attention weights for intense
  C^{mld}: collection of joint attention weights for mild
  p^{int}: probabilistic joint distribution for intense
  p^{mld}: probabilistic joint distribution for mild
  for every input i: (a′ⁱₜ, a^{ji}_{(j,t)}, xⁱ) do
    procedure FUZZIFIER(aⁱₜ, a^{ji}_{(j,t)}, xⁱ)
      Iⁱ is calculated (Eq. 5), and I is updated (Eq. 6)
      truth value [symbol]  (Iⁱ) is calculated (Eq. 6)
      *UPDATE-JOINT-DIST (a′ⁱ_{(j,t)}, [symbol] (Iⁱ)) [symbol]
  Explained at the bottom
      qⁱ = [symbol] qⁱⱼ [symbol]  is calculated (Eq. 10)
      for every joint j do
        ΔH is calculated between qⱼ and Pⱼ^{mld/int}
        Δ\tilde{H} is updated [symbol]
        (qⱼ) is calculated (Eq. 11)
      end for
    return [symbol] (qⱼⁱ) ∀ⱼ, [symbol] (Iⁱ)
  end procedure
end for
procedure *UPDATE-JOINT-DIST(a′_{(j,t)}, [symbol] (I))
  if [symbol]  (I) ≤ [symbol] (I) then
    append C^{mld} (Eq. 7)
    update p^{mld} (Eq. 9)
  else
    append C^{int} (Eq. 8)
    update p^{int} (Eq. 9)
  end if
end procedure
```

The procedure can consist of two average values of intensity score and difference cross entropy, which is updated with every input video frame. It can also include two collections for storing the joint attention weights for mild and intense categories, which are classified by comparing the truth values of intensity scores, and by taking an average and softmax of two probabilistic distributions that are extracted for the corresponding categories. These collections and their corresponding probabilistic distributions preferably are dynamically appended and updated with every new input. The procedure receives the time frames and joints' attention weights as well as the key-point coordinates as input from stage 2 (FIGS. 2 and 3), computes the intensity score I based on Equation 5, updates its average value, maps it to fuzzy set [symbol] using the triangular fuzzy membership function of Equation 6, and updates collections and their corresponding distributions. Next, it computes the q of Equation 10 and the cross-entropy between mild and intense distributions, updates the cross-entropy average value, and maps the q value into fuzzy set P using fuzzy membership function Equation 11. Finally, the procedure returns the truth values of I^{mld}, I^{int}, P^{mld}, and P^{int}.

2) Fuzzy Rules and Inference for Final Indexing

As mentioned above, the final intensity index output is inferred based on fuzzy logic principles on the input sets ( [symbol] and [symbol] for all j)|. Specifically, the input sets are passed through IF-THEN fuzzy logic rules, and then, by combining these rules, the final output fuzzy sets are inferred which denote the intensity index of the performed action. Initially, an intermediate output set is extracted by a linear combination of the following intermediate fuzzy rules, which we have for every set Pj:

Rⱼ^{mld/int}: IF qⱼ is [symbol] ⱼ^{mld/int} THEN q is [symbol] ⱼ^{mld/int}, weight αⱼ (12)

where R^{mld/int} is a set of two rules for every joint coordinate j, P^{mld/int} refers to P^{mld} and/or P^{int} members of the intermediate output fuzzy set P (i.e., P={P^{mld}, P^{int}}) which denotes the aggregated categorization of joints' distribution into mild and/or intense. Each rule R^{mld/int} refers to the corresponding joint's individual decision on the aggregated categorization whose role is weighted by αⱼ. Next, we combine the inferences of these rules using the linear combination of their output fuzzy membership functions to compute the overall membership function of the intermediate output set. This process is an adaptive filter as αⱼs are adaptively learned during the training session on the intensity indexing dataset [21], Since the attention weights demonstrate the exclusive patterns of the action motions, the fuzzy rules will dynamically adapt to every category and index of actions.
The fuzzy membership function of P^{mld/int} is formulated as:

$${μ}_{𝒫}^{mld / int} ( q ) = {\sum }_{j} {α}_{j} {μ}_{{𝒫}_{j} {oR}_{j}}^{mld / int} ( {q}_{j} ) = {\sum }_{j} {α}_{j} {μ}_{{𝒫}_{j}}^{mld / int} ( {q}_{j} ) \qquad ( 13 )$$

where μ [symbol] ^{mld/int}(q) is the intermediate fuzzy membership function, μ [symbol] _{ⱼ}_{∘R}_{ⱼ}^{mld/int}(qⱼ) is the fuzzy membership function for every rule which measures the truth of the relation between P^{mld/int} and every joint's fuzzified distribution set Pⱼ^{mld/int}.

The final output inference of the intensity index is predicted using the intermediate output set and the fuzzified set of intensity score (i.e., μ_{I}), passed through the following final fuzzy inference rules:

R^{mld}: IF I is [symbol] ^{mld} AND q is [symbol] ^{mld} THEN y is Y^{mld} (14)

R^{int}: IF I is [symbol] ^{int} AND q is [symbol] ^{int} THEN y is Y^{int} (14)

where y is the final inference value which belongs to the final index set of Y={Y^{mld}, Yⁱⁿ}. The AND process is performed on fuzzy [symbol] ^{mld/int} and [symbol] ^{mld/int} using “AND-type” inference, which compromise linear combination of t-norm and s-norm of truth values [symbol] (I), [symbol] (q), according to the following equation:

μ_{Y}^{mld/int}=λt-norm+(1−λ)s-norm (16)

where λ parameter can be found in the process of learning subject to the constraint 0<λ<1 along with (αⱼ). Finally, the intensity index is predicted by comparing Y^{mld}*'s and Y^{int}'s truth values, i.e., μ_{Y}^{mld} and μ_{Y}^{int}.

The pseudocode below represents a second algorithm, Algorithm 2, which is a portion of the process performed by stage 3 (FIG. 2) of the fuzzy inference system that outputs the final inference for intensity index based on input fuzzified sets [symbol] ^{mld/int}, [symbol] ^{mld/int}; along with intermediate and final fuzzy logic rules: Rⱼ^{mld/int} and R^{mld/int}, respectively; and combining their output fuzzy sets. The output sets of intermediate rules (Rⱼ^{mld/int}) are combined using a linear combination method and (α_{J}) weights which show the degree of belief to each rule. The output set of the final inference rules can be computed using AND-type of [symbol] ^{mld/int} and [symbol] ^{mld/int}. Finally, the intensity index is inferred by comparing the truth values of the final output fuzzy sets corresponding to mild and intense indexes.

```
Rⱼ^{mld/int}: intermediate fuzzy inference rules for every joint
j (Eq. 12)
αⱼ: represents the role of every joint in the final inference
(Eq. 11)
R^{mld/int}: final fuzzy inference rules (Eq. 14 and Eq. 15)
Y^{mld/int}: final output sets for mild and intense indexes
for every input i do
  ( [symbol] (Iⁱ), [symbol] (qⁱ))=FUZZIFIER(aⁱₜ,a^{ji}_{(j,t)}, xⁱ)
  procedure FUZZY-INFERENCE(( [symbol] (Iⁱ), μ_{ρ}^{mld/int}
(qⁱ)))
    for every joint j do [symbol]  combination of intermediate
      inferences
        μ_{ρ}^{mld/int}(q) + = αⱼ [symbol] (qⱼ) (Eq. 13) [symbol]   Rⱼ^{mld} [symbol]
        (q) + = αⱼ [symbol] (qⱼ) (Eq. 13) [symbol]    Rⱼ^{int}
    end for
    μ_{Y}^{mld} ← AND-type( [symbol] ^{mld}, ρ^{mld}) [symbol]   R^{mld}
    μ_{Y}^{int} ← AND-type( [symbol] ^{int}, ρ^{int}) [symbol]   R^{int}
    return arg max μ_{Y} (y)
          Y ϵ(Y^{mld},Yⁱⁿ)
  end procedure
end for
```

E. Loss Function Update

The ST-LSTM can be initially trained on action recognition data of samples with similar intensity. However, actions performed with different intensities include different motion patterns. Consequently, the pre-trained ST-LSTM may pay attention to the wrong joint coordinates once applied to the generated dataset, which has samples of different intensities. Therefore, preferably a penalty term is added to the loss function to enforce the model to pay attention to the intended joint coordinates by penalizing the wrong attention weights. In this regard, the cross-entropy can be used as a distance between the input joints' distribution of Equation 10, and those of mild and intense categories computed from Equation 9. As such, the action recognition module of the methodology disclosed herein also adapts to the unique way a certain action-intensity is performed, e.g. ‘intense punching’ vs. ‘mild punching.’ This addition of a penalty term, in turn, leads to the further adaptation of the kinetic fuzzy intensity score and of the output fuzzy rules. Equation 17 is the loss function of the LSTM model with the aforementioned penalty term added, enables the model to distinguish mild and intense actions, is given as:

$$L ( y , \hat{y} ; p , q ) = - {\sum }_{t} {y}_{t} log ( {\hat{y}}_{t} ) - λ {\sum }_{j} {p}_{j} log ( {q}_{j} ) \qquad ( 17 )$$

where the first log-based term denotes cross-entropy which is used as a distance function between the real label and the computed softmax of the final output, i.e., y and ŷ, respectively. l is the index of the recognizable actions considered in the model. The penalty term is added through the Lagrange multiplier λ, which increases with the number of input samples related to every action. The second log-based term is the cross-entropy penalty, q denotes the input's distribution of attention weights over the joint coordinates (Equation 10), and p denotes those of the mild and intense categories (Equation 9). j is the index of human key-points/joints coordinates. The loss function in Equation 17 enables the model to distinguish mild and intense actions. It improves action recognition accuracy when the action dataset includes mild and intense intensity indexes.

### Experiments

1) Generated Dataset for Intensity Indexing

In order to evaluate the intensity indexing scheme and the entire integrated model, an additional dataset of human actions was generated with two intensity indexes: (i) intense, and (ii) mild. In part, the objective was to minimize the data requirements for the model. Therefore, a fuzzy system was employed for action intensity indexing, which requires only a small amount of data. The choice of a fuzzy system allows for the use of a pre-existing SBU dataset which is small compared to UCF101 and NTU RGBCD datasets. The SBU dataset contains 8 classes, 3 of which (exchanging object, hugging and shaking hands) cannot be differentiated as mild or intense due to the limitations of the model. Therefore, five other classes were extracted: approaching, punching, kicking, hugging, and pushing. For each of these classes, 100 intense and 100 mild videos were generated. Therefore, the generated dataset includes 1000 samples. The classification of action intensity is subjective in nature, because for each person the perception of action intensity varies, and depends on their physical attributes (e.g., sex, age, height, BMI, etc.). With that in mind, in the generated dataset annotation, students with similar physical attributes were used to perform the action with a certain intensity, and the classification was associated with the subject's own perception toward their performed actions. Generating more clusters (mild, medium, intense) for intensity indexing requires more data. As mentioned, the inventors generated their our own dataset with mild and intense indexes to evaluate the intensity indexing scheme. Therefore, to keep it simple, the inventors decided to stick with just two clusters for the intensity indexing. For future work, more clusters can be added.

2) Spatio-Temporal LSTM

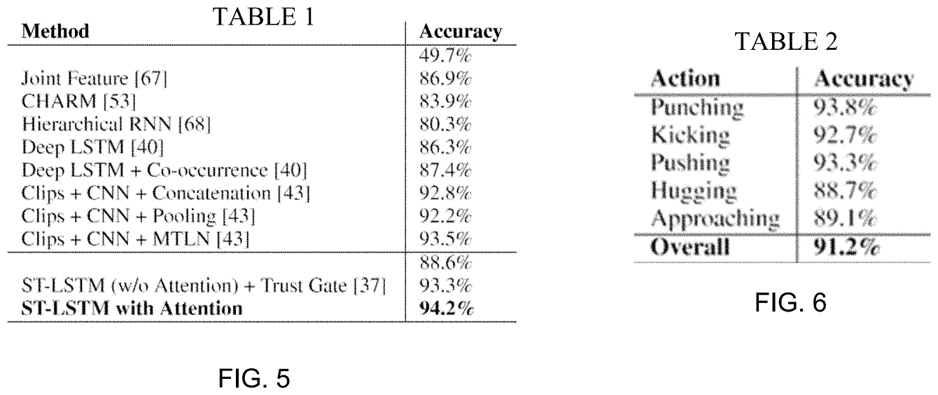

Firstly, the SBU Kinetic dataset, which is used for 3D classification of human key-point coordinates into an action class, was utilized to train the spatio-temporal LSTM 2. Each video in the SBU dataset is restricted to 2 people and each person has 15 joints targeted as key-point coordinates in each frame. A 5-fold cross validation scheme was applied to evaluate the action recognition module. Table 1 shown in FIG. 5 is a comparison of state-of-the-art action recognition models trained on the SBU dataset. The results highlight the importance of the spatio-temporal attention mechanism, which improves the accuracy of the ST-LSTM 2. As shown in Table 1, our ST-LSTM model with attention mechanism enhances the accuracy of the model of and achieves the state-of-the-art performance on SBU Kinetic dataset.

B. Experimental Results

1) Action Recognition

The Spatio-Temporal LSTM module 2 was trained and fine-tuned with the additional dataset of actions performed with various intensities. Since the mild and intense actions are performed differently, in terms of motional patterns, the accuracy of the ST-LSTM module 2 drops significantly, up to 19%. Therefore, the LSTM model 2 was dynamically updated with the results of the fuzzy inference system 3, according to Equation 17, and the system was re-evaluated on the generated dataset to see how the action recognition module's accuracy would be influenced by the integration of the LSTM and intensity indexing modules 2 and 3, respectively. Table 2 shown in FIG. 6 depicts the re-evaluation results on the additional generated dataset showing the average 2.75% decrease in the overall accuracy.

2) Intensity Indexing

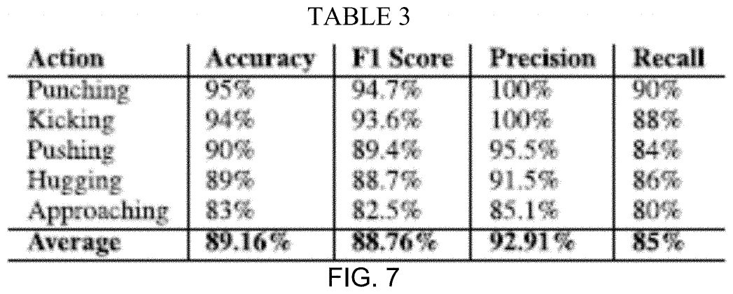

The additional generated dataset was used to evaluate the performance of the intensity indexing methodology performed by stage 3. Table 3 shown in FIG. 7 shows the action intensity indexing performance of the model on the generated dataset. The fuzzy inference rules in Equation 15 and Equation 14 were considered separately to measure the FI score and the averaged results were reported. Due to the strictness of the fuzzy inference rules, the precision of the intensity indexing is comparably higher than other metrics. By using both fuzzy rules jointly, a higher precision was achieved.

Actions such as hugging and approaching are difficult to distinguish between intense and mild. The fuzzy module 3 of the system receives input from the attention weights generated by the spatio-temporal LSTM 2. These attention weights are of two type: one over the time frame, and another over the key-point coordinates in every frame. Key-point coordinates for approaching and hugging do not differ by much for intense and mild classes, resulting in similar attention weights for both intensity indexes, which makes the model drop in accuracy as seen in Table 3.

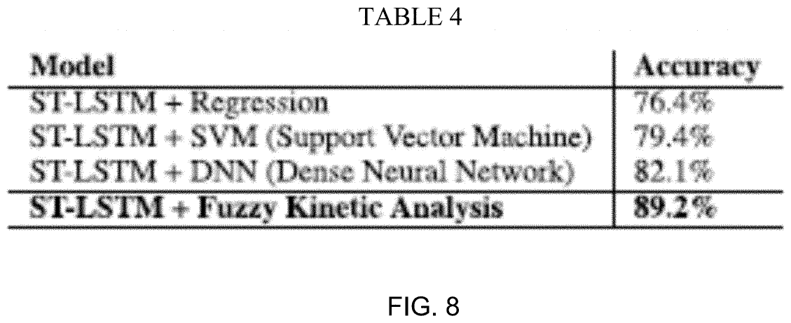

The methodology of the present disclosure was also compared with multi-task learning baselines implemented on top of the ST-LSTM 2 to comprehend the role of the fuzzy kinetic analysis performed by stage 3. The evaluation results of Table 4 shown in FIG. 8 demonstrate the significance of the kinetic fuzzy intensity analysis and indexing modules of the present disclosure. Similar to the evaluation scheme in the action recognition module 2, a 5-fold cross validation was used to evaluate the intensity indexing algorithm for each action class. For evaluation of a model with limited data samples, a k-fold cross validation process is used. In the 5-fold cross validation used for this purpose, 4 folds are used for training and the remaining 1-fold was used for testing. As for the baselines, the attention weights were used as the input features to the SVM and DNN. As indicated above, there are two kinds of attention mechanisms applied on the time frames: one over every frame in the video and another over the key-point coordinates in every frame. These attention mechanisms generate the attention weights that are the input features to the SVM and DNN. The use of SVM, regression or fuzzy modules is to classify the action intensity as intense or mild whereas the ST-LSTM 2 recognizes the action and together the output is the action plus its nature in term of intensity. The use of regression and SVM was for comparing their performance with fuzzy for the task of intensity indexing from the attention weights generated by the ST-LSTM 2.

C. Experimental Discussions

1) Joints' Distributions in Intense vs. Mild Indexes

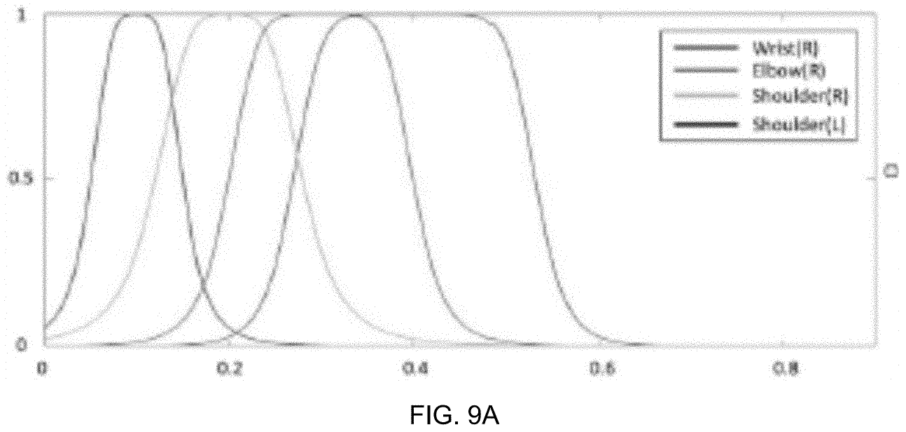

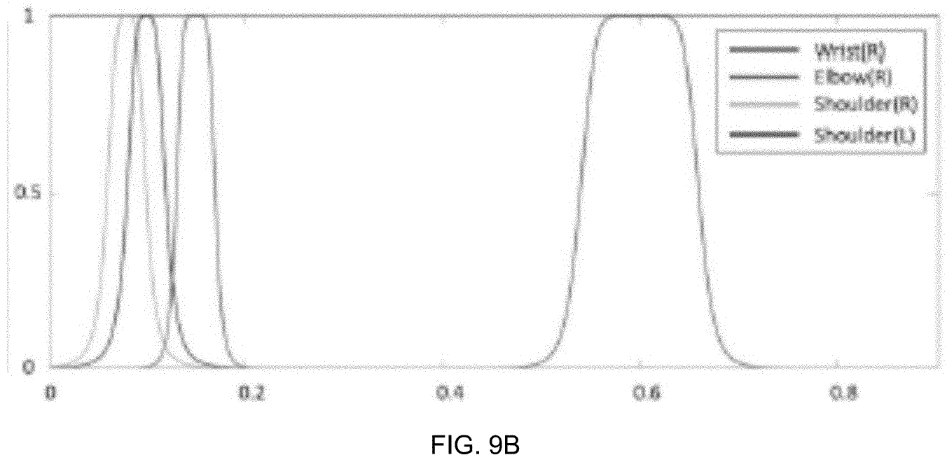

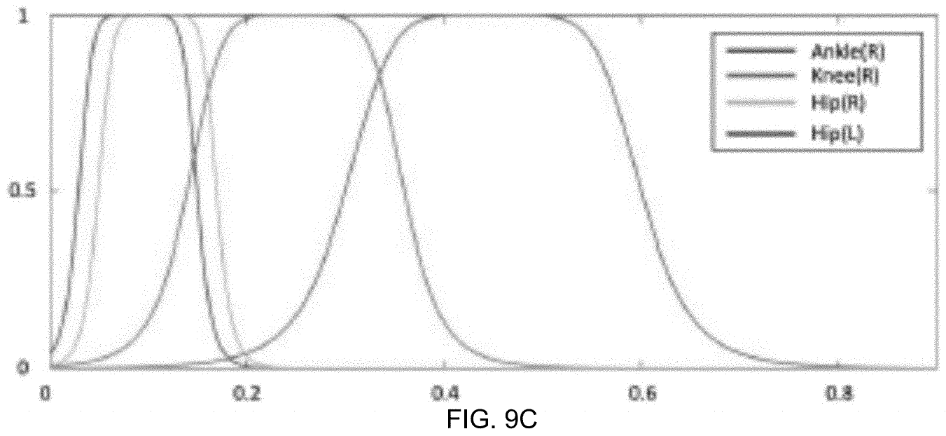

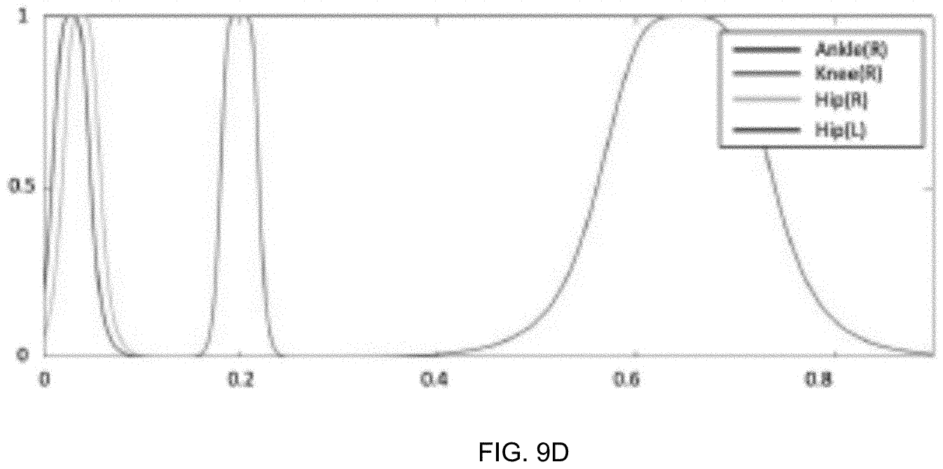

As mentioned earlier, the integrated model dynamically learns the motion of every index of each action category through the weighted distribution of joints corresponding to the attention weights of the LSTM module 2. FIGS. 9A-9D are graphs of the generalized bell membership function fitted to these distributions by assigning a membership score of 1 if the detected index is intense, and 0.5 if the distribution is closer to the intense category but the final intensity score is below the threshold. The attention weights are multiplied by the temporal attention of the time frames. These graphs show these distributions for actions of punching and kicking with mild and intense indexes. The generalized bell function was fitted to these distributions by assigning 1.0 to them if the intensity score is above the average and the cross entropy of intense distribution is less than the mild distribution, 0.5 if the intensity score is less than the average but the cross entropy with the intense distribution is still less, and 0 otherwise.

FIGS. 9A-9D show, on the aggregated level, the distinct distribution of these weights for intense-mild actions. In these figures, the generalized bell membership function was fitted to joints' attention weights extracted from the generated dataset. This illustrates the difference between mild and intense actions in terms of joints' movement and the weight by which the action recognition module 2 is attending to them. As shown in the figures, the distribution of these attention weights for the intense actions tends to have higher variance whereas in the mild actions they are rather dense around the average value. In addition, while the intense actions tend to have a greater number of joints with significant corresponding attention weights, as for the mild actions the attention weight of only one joint have significant value and the rest have trivial values below 0.2. It stands to the reason from this that the model generates fuzzy membership values of intensity indexes for every joint's motional patterns and utilizes it for final indexing inference.

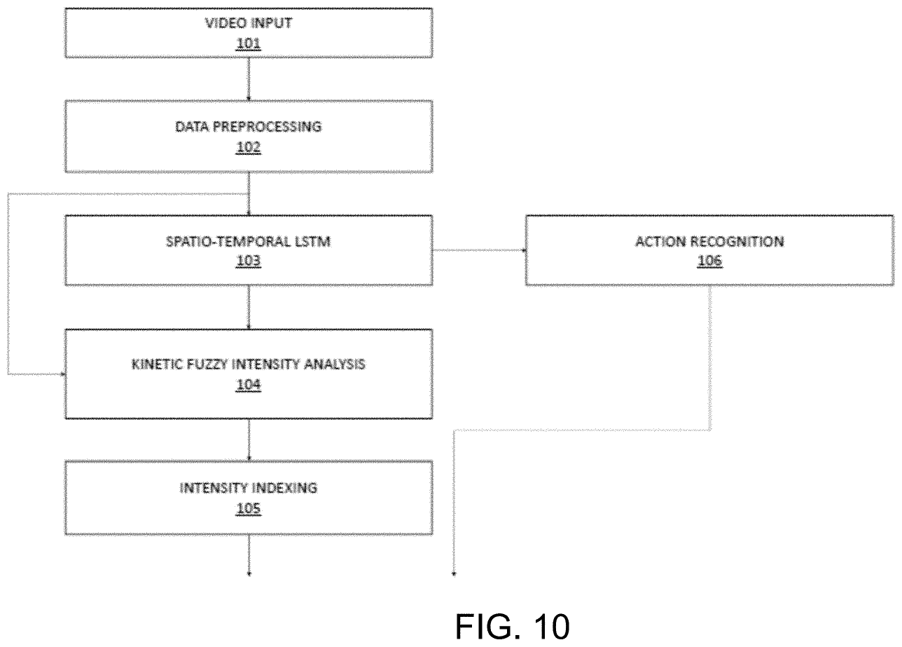

FIG. 10 is a flowchart representing the machine learning method in accordance with a representative embodiment. FIG. 10 shows the high-level topology of the action recognition and intensity indexing model using the fuzzy recurrent attention technique. Steps 101 through 106 in FIG. 10 correspond to the overall pipeline of the Action Intensity Recognition using Fuzzy Recurrent Attention neural network system shown in FIG. 10. Step 101 is a streaming video input from any video source such as webcam, CCTV camera, video files from internet, Internet of Things (IoT) devices, local video files, etc. The frames are passed to the data pre-processing unit 1 (FIG. 2) where the human key-point coordinates of the persons in every frame are detected and also detected are the bounding box co-ordinates of any object, provided an object is present in the frame.

Step 102, which is data pre-processing involves detection of human key-points which is done using a convolutional neural network which in real-time detect a plurality (e.g., 15) of key-points in a human body, e.g., two points on the face, one at the lower neck, three on each arm and three on each leg, summing to fifteen in total. This process preferably also involves object detection using a convolutional neural network famously called a Single Shot Detection (SSD) network to detect the object in the image and put a bounding box around it in the format of x_min, y_min, x_max, y_max.

Step 103 preferably involves a Recurrent Neural Network model called LSTM. The LSTM model preferably utilizes two sorts of attention mechanism: attention over the time frames, and attention over various key-point coordinates. As indicated above, such spatio-temporal attentions help the model to learn the unique way of performing an action with a certain intensity index, such as walking fast or punching hard as shown in FIGS. 1A-1D.

Step 104 in FIG. 10 obtains the output of the attention LSTM model, which is trained to recognize the performed action, and utilizes the parameters of the attention vectors along with fuzzy entropy measures to compute an initial intensity score for actions. This initial kinetic intensity score is utilized to dynamically generate fuzzy rules to specify the index of the intensity, e.g., whether the performed action is ‘intense’ or ‘mild’.

Step 105 in FIG. 10 learns fuzzy logic rules after computing the kinetic intensity score, and the model is able to dynamically detect the intensity index of every action based on the previous computed kinetic intensity score and the distribution of the corresponding attention weights. Firstly, the model stores the intensity scores of every action as well as the relative attention weights of the spatio-temporal LSTM network. Secondly, the model calculates the maximum and minimum of the intensity score and defines a threshold of the average of the maximum and minimum value. Then, the model categorizes the attention weights of the previous performances of the same action as intense if the value is above the threshold, and mild, if otherwise.

Step 106 uses the combination derived from step 105 of the intensity indexing and the output of the spatio-temporal LSTM to determine the intensity and predict the action performed in the video.

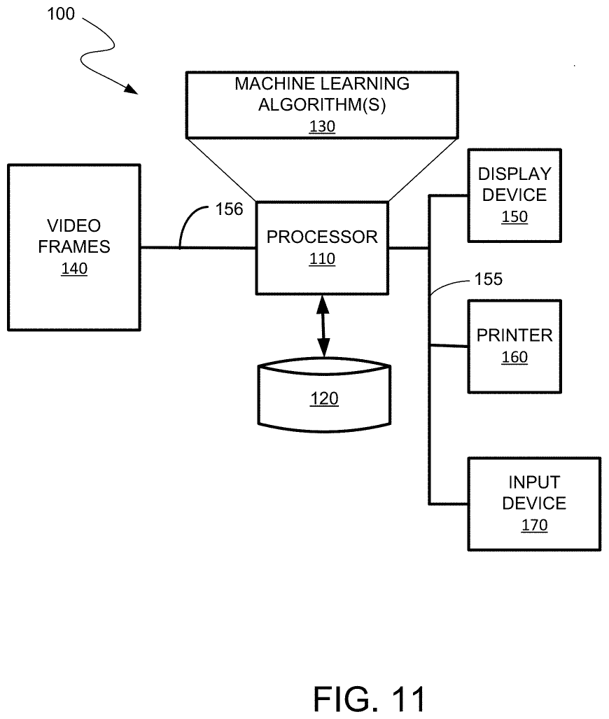

FIG. 11 is a block diagram of the machine system 100 in accordance with a representative embodiment. The three-stage system shown in FIG. 2 can be implemented in a number of ways. In accordance with the embodiment shown in FIG. 10, the system 100 is implemented in software running on one or more processors 110. A memory device 120 in communication with the processor 110 stores computer code comprising the software and may also store the datasets that are used to train and validate the system 100. One or more machine learning algorithms 130 comprising the data pre-processing stage 1 (FIG. 2), the action recognition stage 2 and the intensity index calculation stage 3 are executed by the processor 110 to train the integrated model and, once trained, to use the trained integrated model to perform action recognition and action intensity estimation.

The memory device 120 can be any suitable non-transitory computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the certain embodiments of the present disclosure includes embodying the functionality of the preferred embodiments in logic embodied in hardware or software-configured mediums.

The system 100 can include other devices, such as, for example, a display device 150, a printer 160 and an input device 170, such as a keyboard, a mouse, a scanner, a stylus pen/pad, etc. Such devices will typically be in communication with the processor 110 via a bus 155. The video frames 140 that are input to the first stage 1 (FIG. 2) of the system can be input into the system 100 in a variety of ways. The system 100 can include a video connection 156 for connecting video equipment to the processor 110 for inputting video to the processor 110, or the videos can be stored in the memory device 120 and accessed by the processor 110.

It should be noted that the illustrative embodiments have been described with reference to a few embodiments for the purpose of demonstrating the principles and concepts of the invention. Persons of skill in the art will understand how the principles and concepts of the invention can be applied to other embodiments not explicitly described herein. For example, while particular system arrangements are described herein and shown in the figures, a variety of other system configurations may be used. As will be understood by those skilled in the art in view of the description provided herein, many modifications may be made to the embodiments described herein while still achieving the goals of the invention, and all such modifications are within the scope of the invention.

What is claimed is:

1. A machine learning system for recognizing actions performed by a subject and estimating an intensity of the recognized actions, the machine learning system comprising:
a processor configured to perform an integrated model comprising:
a spatio-temporal action recognition module configured to process key-point coordinates over time obtained from video frames input to the machine learning system to recognize an action taken by the subject;
a fuzzy intensity index calculation module configured to receive attention weights output by the spatio-temporal action recognition module to produce an intensity index associated with the recognized action;
and
a memory device in communication with the processor.

2. The machine learning system of claim 1, wherein the integrated model further comprises:
a pre-processing module configured to receive video frames input to the machine learning system and to transform the received video frames into the key-point coordinates over time.

3. The machine learning system of claim 2, wherein the spatio-temporal action recognition module comprises a trained spatio-temporal Long Short-Term Memory (LSTM) model that has been trained using datasets to recognize actions.

4. The machine learning system of claim 3, wherein the fuzzy intensity index calculation module includes a kinetic fuzzy intensity analysis module that performs a kinetic fuzzy intensity analysis that processes the attention weights to calculate a fuzzy entropy associated with the recognized action.

5. The machine learning system of claim 4, wherein fuzzy intensity index calculation module includes a fuzzy inference module that calculates the intensity index based at least in part on the calculated fuzzy entropy.

6. The machine learning system of claim 5, wherein the spatio-temporal action recognition module comprises a first attention mechanism that calculates attention over time of the video frames and a second attention mechanism that calculates attention over at least some of the key-point coordinates to produce first and second sets of the attention weights, respectively.

7. The machine learning system of claim 6, wherein the fuzzy entropy associated with the recognized action is calculated using the first and second sets of attention weights.

8. The machine learning system of claim 7, wherein the kinetic fuzzy intensity analysis module computes an initial intensity score based on the fuzzy entropy, and wherein the fuzzy inference module converts the initial intensity score and the first and second sets of attention weights into fuzzy sets using an adaptive membership function.

9. The machine learning system of claim 8, wherein the kinetic fuzzy intensity index calculation module uses truth values of the fuzzy sets to define fuzzy rules through which a final intensity index is determined by the fuzzy inference module.

10. A machine learning method for recognizing actions performed by a subject and estimating an intensity of the recognized actions, the machine learning method comprising:
in one or more processors:
performing a spatio-temporal action recognition algorithm that processes key-point coordinates over time obtained from video frames input to the machine learning system to recognize an action taken by the subject; and
performing a fuzzy intensity index calculation algorithm that receives attention weights output by the spatio-temporal action recognition algorithm to produce an intensity index associated with the recognized action;

11. The machine learning method of claim 10, further comprising:
in said one or more processors, performing a pre-processing algorithm that receives video frames and transforms the received video frames into the key-point coordinates over time.

12. The machine learning method of claim 11, wherein the spatio-temporal action recognition algorithm comprises a trained spatio-temporal Long Short-Term Memory (LSTM) model that has been trained using datasets to recognize actions.

13. The machine learning method of claim 11, wherein the fuzzy intensity index calculation algorithm includes a kinetic fuzzy intensity analysis algorithm that performs a kinetic fuzzy intensity analysis that processes the attention weights to calculate a fuzzy entropy associated with the recognized action.

14. The machine learning method of claim 13, wherein fuzzy intensity index calculation algorithm includes a fuzzy inference algorithm that calculates the intensity index based at least in part on the calculated fuzzy entropy.

15. The machine learning method of claim 14, wherein the spatio-temporal action recognition algorithm comprises a first attention mechanism that calculates attention over time of the video frames and a second attention mechanism that calculates attention over at least some of the key-point coordinates to produce first and second sets of the attention weights, respectively.

16. The machine learning method of claim 15, wherein the fuzzy entropy associated with the recognized action is calculated using the first and second sets of attention weights.

17. The machine learning method of claim 16, wherein the kinetic fuzzy intensity analysis algorithm computes an initial intensity score based on the fuzzy entropy, and wherein the fuzzy inference algorithm converts the initial intensity score and the first and second sets of attention weights into fuzzy sets using an adaptive membership function.

18. The machine learning method of claim 17, wherein the kinetic fuzzy intensity index calculation algorithm uses truth values of the fuzzy sets to define fuzzy rules through which a final intensity index is determined by the fuzzy inference module.

19. A machine learning computer program embodied on a non-transitory computer-readable medium for recognizing actions performed by a subject and estimating an intensity of the recognized actions, the machine learning program comprising:
a spatio-temporal action recognition algorithm that processes key-point coordinates over time obtained from video frames input to the machine learning system to recognize an action taken by the subject; and
a fuzzy intensity index calculation algorithm that receives attention weights output by the spatio-temporal action recognition algorithm to produce an intensity index associated with the recognized action;

20. The machine learning computer program of claim 19, further comprising:
a pre-processing algorithm that receives video frames and transforms the received video frames into the key-point coordinates over time.

21. A machine learning-based method for recognition and intensity indexing of human action performance for health, sport, and bullying/fight comprising the steps of:
a) preparing a streaming video of at least one person in the group;
b) extracting the pose of at least one person;
c) recognizing the performed action using an LSTM module with a spatio-temporal attention mechanism;
d) recognizing the action intensity using the spatio-temporal distribution of the attention weights, fuzzy entropy measures and dynamically learned fuzzy logic rules; and
e) dynamically updating the action recognition module as well as the fuzzy logic rules for further adaptation to a unique way an action intensity is performed.
